(19) United States
(12) Patent Application Publication
(10) Pub. No.: US 2008/0295983 A1
(43) Pub. Date: Dec. 4, 2008

(54) Security Paper

(76) Inventors: Burkhard Krietsch, Dieburg (DE); Matthias Kuntz, Seeheim-Jugenheim (DE); Holger Winkler, Darmstadt (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/088,994

(22) PCT Filed: Sep. 20, 2006
(86) PCT No.: PCT/EP06/09131

§ 371 Date: Apr. 2, 2008

(30) Foreign Application Priority Data
Oct. 14, 2005 (DE) 10 2005 049 167.7

(51) Int. Cl. D21H 21/40; B32B 1/00

(52) U.S. Cl. 162/110; 428/206; 162/140; 162/109

(57) ABSTRACT

The invention relates to an optically variable security paper for the production of documents of value which comprises a cellulose-containing substrate which comprises core/shell particles, to processes for the production of a security paper of this type and to the use thereof for the production of documents of value.

The present invention relates to a security paper for the production of documents of value, where the paper comprises a flat cellulose-containing substrate which comprises core/shell particles which provide the paper with an optically variable appearance, improved mechanical stability and improved tear strength. The invention furthermore relates to processes for the production of a security paper of this type and to documents of value which comprise a security paper of this type.

Documents of value and security documents, such as, for example, bank-notes, passports, identity documents, shares, bonds, certificates, cheques, credit notes, entry tickets, travel tickets and the like, are often made from paper or materials which have at least one layer of a cellulose-containing material.

In order to increase the counterfeiting security, documents of this type are provided with a multiplicity of security features. In particular in the case of documents of value which are produced in large quantities, for example banknotes, the type and number of the desirable security features must be balanced against the increased production costs. For this reason, there is a constant search for inexpensive and technically simple solutions which can if possible achieve a multiple benefit and significantly increase the counterfeiting security. Optimal solutions are those which result in security features which can be recognised and checked by anyone, if possible without aids, and can be combined well with the known security features that are frequently employed.

Papers for use in the security sector must have high mechanical resistance. Banknotes, in particular, are subjected to large mechanical and environmental stresses. In addition, the circulation life of banknotes is frequently determined by their degree of soiling.

Banknote papers are usually very porous due to the principal use of cotton fibres and therefore have a high tendency towards soiling in circulation. In order to increase the circulation life, it has therefore been proposed to provide banknote papers with coatings which are intended to reduce the pick-up of dirt by the papers.

Thus, DE 198 29 004 A1 describes a security paper which has on at least one of its surfaces a coating which consists merely of a binder. This layer is said to form a continuous surface film on the surface of the paper, minimising access of dirt to the fibre. Binders which can be employed are acrylates or polyurethanes.

DE 103 27 083 A1 discloses a security paper which has a coating comprising two layers whose lower layer seals the pores of the paper substrate, while the upper lacquer layer protects the substrate against physical and chemical influences. Both layers may comprise common polymers.

It is likewise known to provide security papers with polymeric layers which are intended to provide the paper with additional strength and water-repellent properties, as described, for example, in EP 1 115 948 B1.

DE-A 2 307 894 also discloses a process in which plastic-containing papers are produced by adding polymeric materials to the paper stock. However, the suspension used must contain particles having sizes of 4 to 30 μm in order that they can be taken up by the paper fibres during the papermaking process in order to provide the paper with strength.

Core/shell particles have also already been described for use in papers. Thus, DE 197 27 060 A1 describes a process for the preparation of coarse aqueous polymer dispersions which are said to be suitable for the finishing of paper. The properties that the papers treated therewith have were not described.

EP 0 441 559 A2 discloses core/shell particles which have a cavity between core and shell and can likewise be used for papermaking. These provide the paper treated therewith hiding power, brightness and lustre and can replace part of the additives that are otherwise usual, such as kaolin or titanium dioxide.

In order to tint papers, corresponding dyes in particulate or dissolved form are either introduced into the paper pulp or applied via the sizing. This enables paper either to be uniformly coloured or provided with functional dyes, for example with photoluminescent coloured pigments. However, an optically variable appearance cannot be achieved by the use of optically variable pigments in the paper pulp since the paper fibres at least partly cover the pigments and hinder their alignment.

The object of the present invention was to provide a security paper which has an optically variable appearance and at the same time increased tear strength, good mechanical stability, a low soiling tendency and a tactile surface which is clearly different from untreated paper and can be produced by a simple process which can readily be integrated into the conventional papermaking process by addition of essentially a single substance.

The object of the present invention is achieved by an optically variable security paper for the production of documents of value which comprises a flat cellulose-containing substrate which comprises core/shell particles whose core is essentially solid and dimensionally stable and has an essentially monodisperse size distribution, where the core is chemically bonded to the shell via an interlayer, the weight of the shell is equal to or greater than the weight of the core, and there is a difference between the refractive indices of the core material and shell material.

The object of the invention is likewise achieved by a process in which core/shell particles whose core is essentially solid and dimensionally stable and has an essentially monodisperse size distribution and where the core is chemically bonded to the shell via an interlayer, the weight of the shell is equal to or greater than the weight of the core, and there is a difference between the refractive indices of the core material and shell material, are introduced into an aqueous paper pulp and subsequently converted into a paper sheet together with the conventional paper raw materials.

In addition, the object of the invention is also achieved by a process in which an aqueous dispersion comprising core/shell particles whose core is essentially solid and has an essentially monodisperse size distribution and where the core is chemically bonded to the shell via an interlayer, the weight of the shell is equal to or greater than the weight of the core, and there is a difference between the refractive indices of the core material and shell material, is applied to at least part of the surface of an unsized or sized paper and subsequently dried.

The object of the invention is additionally also achieved by the use of the above-mentioned security paper for the production of documents of value, such as banknotes, passports, identity documents, shares, bonds, certificates, cheques, credit notes, entry tickets, travel tickets and the like, and by the provision of documents of value of this type.

Like other papers, security papers are produced in a papermaking machine in which the following working steps are generally carried out successively: stock preparation, stock processing, the wire section, the press section, the dryer section, surface finishing, smoothing, and cutting.

Stock preparation here serves principally for producing the cellulose-containing starting material for papermaking. This can be obtained from various vegetable fibres or also from rags. Security paper is preferably produced using cotton fibres, which can be obtained either directly from cotton plants, but also from rags.

In the pulper, the various paper ingredients, which consist of the cellulose-containing paper raw material and various additives, are mixed with water to give a paper suspension, the pulp. The additives here are selected so that they influence a very wide variety of desired properties of the paper, such as colour, smoothness, whiteness, weight per unit area, strength, water-repellent properties, etc., but may also contain particles or fibres which already provide the finished security paper with security features, such as, for example, planchettes (small paper or plastic platelets), fibres of various materials (for example plastics), which may also, inter alia, have photoluminescent properties, fluorescent starlets, chemical additives which can be detected with the aid of special light sources or exhibit specific chemical reactions, and the like.

In the wire section, the highly diluted aqueous paper suspension is distributed uniformly on a circulating wire screen, where excess water runs off or is removed by suction. True watermarks are also introduced into the paper in this wire section.

The excess water is removed in the press section, and the consolidated paper web formed is dried in the dryer section under the action of heat.

In the surface finishing which usually follows, the paper is subjected to a so-called sizing or coating process, which generally reduces the sorbency of the paper. This sizing is usually carried out with binders and/or pigments and serves to produce the desired surface properties, such as weight per unit area, relative moisture content, toner adhesion and fixing, porosity, pH, lustre, whiteness and the like.

This is followed by a smoothing process, in which the paper web is passed through a plurality of rolls, and finally paper cutting.

It can be seen from the process sequence roughly outlined here that, during papermaking, pressure and temperature act repeatedly on the paper raw materials or on the paper web forming. The raw materials and additives employed in papermaking have to withstand this temperature and pressure load in order to be able to achieve the desired effects, unless the changes in the stock properties caused by pressure and temperature produce precisely the desired effects.

The security paper in accordance with the present invention comprises a cellulose-containing substrate, which consists of the usual materials for the production of security papers, i.e. preferably comprises cellulose from vegetable fibres and/or rags and in particular cellulose fibres from cotton. In addition, the cellulose-containing substrate may likewise comprise plastic fibres and further conventional additives. The choice of additives here is dependent on the desired paper properties and can vary greatly. For the purposes of the present invention, the nature of the additives is not crucial and is therefore not limiting so long as they do not react chemically with the core/shell particles in accordance with the present invention. To this extent, the expert knowledge of the papermaker will determine what additives he adds to the production process for the production of the security paper according to the invention.

The cellulose-containing substrate is preferably a sized or unsized paper.

The cellulose-containing substrate for the security paper in accordance with the present invention comprises core/shell particles whose core is essentially solid and dimensionally stable and has an essentially monodisperse size distribution, where the core is chemically bonded to the shell via an interlayer. The weight of the shell here is equal to or greater than the weight of the core, and the material of which the core consists and the material of which the shell consists (the core material and the shell material) are selected so that there is a difference in the refractive indices between the two. The weight of the shell is preferably greater than the weight of the core.

The cores of the core/shell particles have an essentially spherical, in particular ball-like shape and have an essentially monodisperse size distribution, i.e. they have a very narrow particle-size distribution.

The average particle diameter of the core particles is in the range 30-400 nm, in particular in the range 60-350 nm and particularly preferably in the range 90-300 nm. In general, the particle diameter of the core particles is about 60 to about 80%, in particular about 65 to about 75%, of the total diameter of the core/shell particles.

The core/shell particles have an average particle diameter in the range from about 50-800 nm. In particular, particles in the range 100-500 nm are employed and particularly preferably particles having a particle diameter of 150-400 nm. In these particle-size ranges, optical effects in the visible wavelength region of light can preferably be expected.

However, it is also possible to employ core/shell particles whose size corresponds to a multiple of the particle sizes described here.

The cores of the core/shell particles are essentially solid and dimensionally stable. This means that the cores either do not become flowable under the processing conditions in the papermaking process or during production of the core/shell particles or become flowable at a temperature above the melting point of the shell material. Under the same conditions, the material of which the cores consist is also virtually non-swellable.

In order to achieve this, the core materials selected are preferably organic polymeric materials having a correspondingly high glass transition temperature (T_{g}) or alternatively inorganic core materials.

The cores preferably consist of or predominantly comprise an organic polymeric material which is, in particular, crosslinked.

Both polymers and copolymers of polymerisable unsaturated monomers and also polycondensates and copolycondensates of monomers having at least two reactive groups, such as, for example, high-molecular-weight aliphatic, aliphatic/aromatic or fully aromatic polyesters, polyamides, polycarbonates, polyureas and polyurethanes, but also amino resins and phenolic resins, such as, for example, melamine-formaldehyde, urea-formaldehyde and phenol-formaldehyde condensates, are suitable. Epoxy resins are also suitable as core material.

In a preferred variant of the invention, the polymers of the core material are advantageously crosslinked (co)polymers since these usually only exhibit their glass transition at high temperatures. These crosslinked polymers may either already have been crosslinked in the course of the polymerisation or polycondensation or copolymerisation or copolycondensation, or they may have been post-crosslinked in a separate process step after completion of the actual (co)polymerisation or (co)polycondensation.

The monodisperse cores of organic polymeric materials are preferably obtained by emulsion polymerisation. Regarding the course of this process and all assistants and additives used, such as, for example, polymerisation initiators, dispersion aids, emulsifiers, crosslinking agents and the like, express reference is made here to the corresponding comments in EP 0 955 323 A1 and in WO 03/025035 A2.

In another, likewise preferred variant of the invention, the core consists entirely or predominantly of an inorganic material, preferably a metal or semimetal or a metal chalcogenide or metal pnictide.

For the purposes of the present invention, chalcogenides are taken to mean compounds in which an element from group 16 of the Periodic Table of the Elements is the electronegative bond partner; pnictides are taken to mean those in which an element from group 15 of the Periodic Table of the Elements is the electronegative bond partner.

Preferred cores consist of metal chalcogenides, preferably metal oxides, or metal pnictides, preferably nitrides or phosphides. For the purposes of these terms, metals are all elements which are able to occur as electro-positive partner compared with the counterions, such as the classical sub-group metals or the main-group metals from the first and second main groups, but equally also all elements from the third main group, as well as silicon, germanium, tin, lead, phosphorus, arsenic, antimony and bismuth. The preferred metal chalcogenides and metal pnictides include, in particular, silicon dioxide, aluminium oxide, gallium nitride, boron nitride, aluminium nitride, silicon nitride and phosphorus nitride.

The starting material employed for the production of the core/shell particles in a variant of the present invention is preferably monodisperse cores of silicon dioxide, which can be obtained, for example, by the process described in U.S. Pat. No. 4,911,903. The cores here are produced by hydrolytic poly-condensation of tetraalkoxysilanes in an aqueous/ammoniacal medium, where firstly a sol of primary particles is produced, and the resultant SiO₂ particles are subsequently brought to the desired particle size by continuous, controlled metered addition of tetraalkoxysilane. This process enables the production of monodisperse SiO₂ cores having average particle diameters between 0.05 and 10 μm with a standard deviation of 5%.

The starting material is also preferably SiO₂ cores which have been coated with (semi)metals or metal oxides which do not absorb in the visible region, such as, for example, TiO₂, ZrO₂, ZnO₂, SnO₂ or Al₂O₃. The production of SiO₂ cores coated with metal oxides is described in greater detail, for example, in U.S. Pat. No. 5,846,310, DE 198 42 134 and DE 199 29 109.

The starting material employed can also be monodisperse cores of non-absorbent metal oxides, such as TiO₂, ZrO2, ZnO2, SnO₂ or Al₂O₃, or mixtures of metal oxides. The preparation thereof is described, for example, in EP 0 644 914. The process of EP 0 216 278 for the production of monodisperse SiO₂ cores can furthermore readily be applied to other oxides with the same result. Tetraethoxysilane, tetrabutoxytitanium, tetrapropoxy-zirconium or mixtures thereof are added in one portion with vigorous mixing to a mixture of alcohol, water and ammonia whose temperature is precisely set to 30 to 40° C. using a thermostat, and the resultant mixture is stirred vigorously for a further 20 seconds, during which a suspension of monodisperse cores in the nanometre region forms. After a post-reaction time of 1 to 2 hours, the cores are separated off in a conventional manner, for example by centrifugation, washed and dried.

Also suitable as starting material for the production of the core/shell particles are monodisperse cores of polymers which comprise included particles which consist, for example, of metal oxides. Materials of this type are offered, for example, by micro caps Entwicklungs-und Vertriebs GmbH in Rostock. Microencapsulations based on polyesters, polyamides and natural and modified carbohydrates are manufactured in accordance with customer-specific requirements.

It is furthermore possible to employ monodisperse cores of metal oxides which have been coated with organic materials, for example silanes. The monodisperse cores are dispersed in alcohols and modified using standard organoalkoxysilanes. The silanisation of spherical oxide particles is also described in DE 43 16 814.

The size and particle-size distribution of the cores can be set particularly well if the cores consist predominantly or exclusively of organic polymers and/or copolymers. The cores preferably consist predominantly of a single polymer or copolymer and particularly preferably of polystyrene.

The cores of the core/shell particles may likewise comprise a contrast material. This can be a soluble or insoluble colorant. Soluble colorants are generally soluble, usually organic dyes, which can be of natural or synthetic origin and are generally selected from the compound classes of the carbonyl colorants, such as quinones, indigoid colorants and quinacridones, the cyanine colorants, such as di- and triarylmethanes and quinonimines, the azo colorants, the azomethines and methines, the isoindoline colorants, the phthalocyanines and the dioxazines. Insoluble colorants are organic or inorganic coloured pigments. These are preferably absorption pigments and, in a variant of the invention, particularly preferably black pigments, for example carbon black.

However, these contrast materials are usually inorganic or organic pigments, which can be of natural or synthetic origin. For the purposes of the present invention, pigments are taken to mean any solid substance which exhibits an optical effect in the visible wavelength region of light or has certain functional properties. In particular, the term pigments is applied to substances which conform to the definition of pigments in accordance with DIN 55943 or DIN 55944. According to this definition, a pigment is an inorganic or organic, coloured or uncoloured colorant which is virtually insoluble in the application medium or a substance which has particular properties, for example magnetic, electrical or electromagnetic properties, and is virtually insoluble in the application medium. The shape of these pigments is not important here, in particular they can be of a spherical, flake-form or needle-shaped nature or have irregular particle shapes.

It goes without saying that pigments which are incorporated into the cores of the core/shell particles have an average particle size which is not greater than the average particle size of the cores.

The contrast agents employed in the cores can also be luminescent compounds. Luminescent compounds are taken to mean substances which emit machine-measurable and optionally visible radiation due to excitation in the visible wavelength region, in the IR or UV wavelength region of light, due to electron beams or due to X-rays. These also include substances which emit radiation due to excitation in an electromagnetic field, so-called electroluminescent substances, which optionally additionally luminesce due to excitation in the UV or IR wavelength region. Suitable for this purpose are all known particulate and soluble substances having the above-mentioned properties. The particulate substances here have a suitable particle size, i.e. have an average particle size which does not exceed the average particle diameter of the cores. The luminescent particles are therefore particularly preferably in the form of nanoparticles or in the form of so-called quantum dots.

The particulate substances do not necessarily have to be in pure form, but instead may likewise include microencapsulated particles and support materials impregnated, doped or coated with luminescent substances. For this reason, luminescent substances can be incorporated into the cores or as cores of the core/shell particles. This relates both to soluble and also particulate luminescent materials.

Besides organic luminescent substances of any type, examples which may be mentioned of luminescent substances are, for example, the following compounds: Ag-doped zinc sulfide ZnS:Ag, zinc silicate, SiC, ZnS, CdS, which has been activated by Cu or Mn, ZnS/CdS:Ag; ZnS:Cu, ZnS:Tb; ZnS:Al; ZnS:TbF₃; ZnS:Eu; ZnS:EuF₃; Y₂O₂S:Eu; Y₂O₃:Eu; Y₂O₃:Tb; YVO₄:Eu; YVO₄:Sm; YVO₄:Dy; LaPO₄:Eu; LaPO₄:Ce; LaPO₄:Ce, Tb; Zn₂SiO₄:Mn; CaWO₄; (Zn,Mg)F₂:Mn; MgSiO₃:Mn; ZnO:Zn; Gd₂O₂S:Tb; Y₂O₂S:Tb; La₂O₂S:Tb; BaFCl:Eu; LaOBr:Tb; Mg tungstate; (Zn,Be) silicate:Mn; Cd borate:Mn; [Ca₁₀(PO₄)₆F, Cl:Sb, Mn]; (SrMg)₂P₂O₇:Eu; Sr₂P₂O₇:Sn; Sr₄Al₁₄O₂₅:Eu; Y₂SiO₅:Ce, Tb; Y(P,V)O₄:Eu; BaMg₂Al₁₀O₂₇:Eu or MgAl₁₁O₁₉:Ce,Tb. This list is merely illustrative and should therefore not be regarded as final.

Magnetic particles whose average particle diameter does not exceed the average particle diameter of the cores of the core/shell particles can like-wise be incorporated into the cores of the core/shell particles. This is readily possible, in particular, if an organic polymer is used as core material.

In principle, all magnetic particles which consist of magnetisable materials or comprise magnetisable materials as the core, coating or doping are suitable for this purpose. Magnetisable materials which can be employed here are all known materials, such as magnetisable metals, magnetisable metal alloys or metal oxides and oxide hydrates, such as, for example, γ-Fe₂O₃ or FeOOH. Their usability is determined merely by the average particle size, which must not be greater than the average particle size of the cores. Their shape is not important here, in particular needle-shaped magnetic particles may also be incorporated.

For the purposes of the invention, fibrous or particle-shaped additives which are essentially transparent and colourless are also to be regarded as contrast agents. These are preferably particles or fibres of plastics, glass or other solid, transparent materials which are different from the core material and are introduced into the core material in order to increase the mechanical strength of the core/shell particles.

As for the core material, suitable polymers for the polymeric shell material are in principle those from the classes already mentioned above, so long as they have been selected or built up in such a way that they conform to the specification given for the shell polymers. This means that the shell material must have a refractive index which is different from the refractive index of the core material. This determines that the core and shell cannot simultaneously consist of the same material. It is not important here whether the core or shell has the higher refractive index. However, it is advantageous for the core to consist of a material having a higher refractive index than the shell material.

In order to achieve a clear optically variable effect, it has been found that the difference between the refractive indices of the core and shell material should be at least 0.01 and in particular at least 0.1.

In order to achieve attractive optical effects and with respect to further processing of the security paper in accordance with the present invention, it is likewise advantageous for the shell material to be capable of film formation. This means that the shell material can be heated to a temperature at which the shell is flowable. In the process, the shell is softened, viscoelastically plasticated or liquefied. The shell material here has a melting point which is significantly lower than the melting point of the core material. The flowability of the shell material can be achieved by the action of elevated pressure alone, but also by the action of elevated pressure and elevated temperature.

In the simplest embodiment of the present invention, the shell material is already softened in such a way that it becomes capable of film formation by the action of pressure or pressure and temperature during the conventional papermaking process.

In a further embodiment, the shell material is only softened in such a way that it becomes capable of film formation by the action of pressure or pressure and heat in a pressing and/or embossing process in a process step following the papermaking process.

However, it is likewise advantageous for the shell material already to have been softened by the application of pressure or pressure and temperature during the conventional papermaking process, where the degree of softening can be further increased and the filmability of the material thus improved by subsequent pressing and/or embossing processes.

Polymers which meet the specifications for the shell material are likewise in the groups of the polymers and copolymers of polymerisable unsaturated monomers, and also the polycondensates and copolycondensates of monomers having at least two reactive groups, such as, for example, high-molecular-weight aliphatic, aliphatic/aromatic or fully aromatic polyesters and polyamides.

Taking into account the above conditions for the properties of the shell polymers, selected building blocks from all groups of organic film formers are in principle suitable for the preparation thereof.

Some further examples may illustrate the broad range of polymers which are suitable for the preparation of the shells.

If the shell is to have a comparatively low refractive index, polymers such as polyethylene, polypropylene, polyethylene oxide, polyacrylates, poly-methacrylates, polybutadiene, polymethyl methacrylate, polytetrafluoroethylene, polyoxymethylene, polyesters, polyamides, polyepoxides, poly-urethane, rubber, polyacrylonitrile and polyisoprene and copolymers thereof, for example, are suitable.

If the shell is to have a comparatively high refractive index, polymers having a preferably aromatic basic structure, such as polystyrene, polystyrene co-polymers, such as, for example, SAN, aromatic-aliphatic polyesters and polyamides, aromatic polysulfones and polyketones, polyvinyl chloride, polyvinylidene chloride, and, given a suitable choice of a high-refractive-index core material, also polyacrylonitrile or polyurethane, for example, are suitable for the shell.

The shell materials employed can also be elastically deformable polymers, such as, for example, various polyurethanes, low-molecular-weight poly-esters, silicones or polyether- or polyester-modified silicones.

Like the cores, the shells of the core/shell particles may also comprise a contrast agent. Essentially all contrast agents which have already been described above for uptake into the cores of the core/shell particles are suitable here. In contrast to the uptake of the contrast agents into the cores, the particulate contrast agents are not, however, subject to any significant size restriction on incorporation into the shells. Instead, solid, particulate contrast agents whose particle sizes are significantly larger than the average particle diameters of the core/shell particles themselves can also be incorporated into the shells of the core/shell particles. This is attributable to the fact that the shell materials employed have a clear “adhesion tendency” with respect to foreign particles. The shape of the insoluble contrast agents employed is not restricted either on incorporation into the shells of the core/shell particles, instead contrast agents in any suitable shape can be employed.

In addition to the contrast agents, assistants and additives which are not of a particulate nature, for example flow improvers, dispersion aids, emulsifiers and the like, can also be incorporated into the shells of the core/shell particles.

The cores of the core/shell particles used in accordance with the invention are chemically bonded to the shell via an interlayer. This means that the cores are modified in such a way that bonding of the shell takes place via chemical bonds, but not by simple physical attachment. They are preferably covalent bonds. In certain cases, however, electrostatic bonding of the shell to the core is also sufficient.

In a preferred embodiment of the invention, the interlayer is a polymeric interlayer, for example a layer of crosslinked or at least partially crosslinked polymers. The crosslinking of the interlayer can take place here via free radicals, for example induced by UV irradiation, or preferably via di- or oligofunctional monomers. Preferred interlayers in this embodiment comprise 0.01 to 100% by weight, particularly preferably 0.25 to 10% by weight, of di- or oligofunctional monomers. Preferred di- or oligofunctional monomers are, in particular, isoprene and allyl methacrylate (ALMA). Such an interlayer of crosslinked or at least partially crosslinked polymers preferably has a thickness in the range from less than 1 nm to 20 nm. If the interlayer is thicker, the refractive index of this layer is selected so that it either corresponds to the refractive index of the core material or to the refractive index of the shell material.

If copolymers which, as described above, contain a crosslinkable monomer are employed as interlayer, the person skilled in the art is presented with absolutely no problems in suitably selecting corresponding copolymerisable monomers. For example, corresponding copolymerisable monomers can be selected from a so-called Q-e scheme (cf. textbooks of macromolecular chemistry). Thus, monomers such as methyl methacrylate and methyl acrylate can preferably be polymerised with ALMA.

In another, likewise preferred embodiment of the present invention, the shell polymers are grafted directly onto the core via corresponding functionalisation of the core. The surface functionalisation of the core forms the above-mentioned interlayer. The type of surface functionalisation here depends principally on the material of the core. Silicon dioxide surfaces can be suitably modified, for example, by means of silanes carrying correspondingly reactive end groups, such as epoxy functions or free double bonds. Other surface functionalisations, for example for metal oxides, can take place with titanates or organoaluminium compounds, which in each case contain organic side chains having corresponding functions. In the case of polymeric cores, a styrene functionalised on the aromatic ring, such as bromostyrene, can be employed, for example, for the surface modification. The growing-on of the shell polymers can then be achieved via this functionalisation. In particular, the interlayer can also effect adhesion of the shell to the core via ionic interactions or complex bonds.

In a preferred embodiment, the shell of the core/shell particles consists of essentially uncrosslinked organic polymers, which have preferably been grafted onto the core via an at least partially crosslinked interlayer.

The shell here can either consist of thermoplastic or of elastomeric polymers. Since the shell essentially determines the material properties and the processing conditions of the core/shell particles, the person skilled in the art will select the shell material in accordance with usual considerations in polymer technology.

The interlayer in the core/shell particles employed in accordance with the invention guarantees stability of the core/shell particles to the influence of elevated pressure and elevated temperature, which ensures that no phase separation of core and shell occurs under these conditions. By contrast, the structure of core/shell particles whose shell is merely placed against the core cannot be retained under the action of elevated pressure and elevated temperature. Exertion of pressure, in particular, will in this case result in the shell material being separated from the core material and consequently the optical effect previously achievable by the different refractive indices of core and shell being eliminated.

The weight of the shell in the core/shell particles employed in accordance with the invention is equal to or greater than the weight of the core. The core:shell weight ratio is preferably in the range from 1:1 to 1:5, particularly preferably in the range from less than 1:1 to 1:3 and in particular in the range from 1:1.1 to 2:3. This core:shell weight ratio is an essential feature of the present invention. Only via a sufficiently large proportion by weight of the shell and the large number of polymer chains thus present is it possible for the core/shell particles to be retained on the fibrous paper raw materials in the papermaking process, even in the case of particle sizes which are low overall, and not to be removed from the paper suspension by the wire.

Furthermore, the comparatively high proportion by weight of the shell is the prerequisite for the core/shell particles employed in accordance with the invention being able to arrange themselves in a substantially regular structure during drying and smoothing of the paper substrate since the polymeric shell material usually already softens to a certain degree under the usual papermaking conditions and is at least partially converted into a film within the fibre structure of the paper.

Since the core/shell particles can only be admixed in a limited amount with the paper stock, a lower proportion by weight of the shell would, by contrast, not result in the formation of a film phase at all.

Core/shell particles which are suitable for the security paper in accordance with the present invention can be produced, for example, in accordance with the examples given in WO 03/025035.

The core/shell particles described above are present in the cellulose-containing substrate in a first embodiment of the security paper in accordance with the present invention.

For this purpose, the core/shell particles, preferably in the form of an aqueous dispersion, are admixed with the usual starting materials. As already described above, these include the cellulose-containing paper raw material and the various additives. Depending on the desired paper properties, these are selected expertly by the papermaker and are only limited inasmuch as they must not undergo any chemical reactions with the above-mentioned core/shell particles that change the optical properties of the core/shell particles.

As already described above, additives which are suitable for the formation of independent security features in the finished security paper, for example planchettes, fibres of various materials, photoluminescent fibres, photo-luminescent particles, such as, for example, fluorescent starlets, or chemical additives which can be detected with the aid of special light sources or exhibit specific chemical reactions, may also already have been admixed with the paper suspension prepared from the starting materials. In the same way, magnetic or electrically conductive substances may be present.

The core/shell particles employed in accordance with the invention provide the security paper in accordance with the present invention with an optically variable character.

Within the paper stock, the cores apparently at least partly form regular structures which form a diffraction grating, which causes interference phenomena.

It has not been definitively explained, but it is assumed that the mere exertion of pressure and temperature under the usual conditions in the paper-making machine is sufficient to soften the shell of the core/shell particles sufficiently that the shell material at least partially forms a matrix in the paper in which the cores are able to arrange themselves regularly.

Three-dimensional structures can form here by means of which a long-range order of the cores is achieved, which approximately corresponds, at least from domain to domain, to cubic face-centred spherical closest packing. The regularly arranged cores here form a diffraction grating at which reflection, interference and scattering of the incident light occur simultaneously. The achievable optical appearance here is also crucially determined by the refractive-index difference of the core and shell materials and by the particle diameter of the cores. It goes without saying that the difference in the refractive indices of core and shell should be as large as possible since this enables the most impressive optically variable effects to be obtained in the security paper. This is achieved, for example, in the case of the choice of polystyrene as core polymer and polyethyl acrylate as shell polymer, giving a refractive-index difference of 0.12. However, material combinations whose refractive-index difference is smaller are also suitable. These result in opalescent effects, which are likewise optically variable.

Optically variable effects are taken to mean those which lead to a different visually perceptible colour and/or brightness impression at different illumination and/or viewing angles. In the case of different colour impressions, this property is referred to as colour flop. These provide the security paper in accordance with the present invention with uncopyable colour and lustre impressions which are readily perceptible with the naked eye.

The optically variable colour impressions here can be perceived as an interplay of two or more clearly distinguishable discrete colours or as a colour progression between different colour end stages. Both effects can readily be perceived by the human eye, but cannot be copied in commercially available colour copiers, especially as, although these effects are readily visible in the presence of the core/shell particles in the cellulose-containing substrate of the security paper, they are not loud.

The addition of core/shell particles of various size and composition enables the optically variable colouring of security paper to be steered in a simple manner, for example if different colours are desired for different denominations of banknotes, without other components or process steps of the papermaking process having to be modified.

Due to the usual paper thicknesses produced using conventional paper-making processes, the security paper in accordance with the present invention has a certain degree of transparency. A special feature of the security paper according to the invention can thus readily be observed, namely that it has mutually complementary optically variable colours in incident light or transmitted light. This means that, for example, a colour flop from violet to blue-green perceived when viewed from the top is associated with a complementary colour flop from yellow-green to orange on looking through the paper.

The optically variable properties of the security paper according to the invention can also subsequently be enhanced, for example by subsequent pressure or temperature and pressure treatment. In particular by pressing and/or embossing processes over part of the surface, specific effects can thus be produced at predetermined points of the security paper. Thus, for example, the true watermarks present in the paper are characterised in that the paper layer is particularly thin at these points. If core/shell particles are present in the paper stock, a specific embossing process at the point of the watermark enables the latter to be emphasised in a particularly transparent and at the same time optically variable manner. At the same time, the complementary colour flops can be observed particularly well at the points emphasised in this way on looking through the paper. The watermark, as the most popular security feature in paper and paper-like materials, is thus considerably emphasised and enhanced both visually and in terms of security.

At the same time, the addition of the core/shell particles to the security paper according to the invention achieves increased mechanical strength of the paper, in particular increased tear strength, and improved water-repellent properties of the security paper. The porosity of the security paper likewise decreases, enabling a reduced tendency towards soiling to be noted. The tactile properties of the security paper in accordance with the present invention likewise improve. The addition of the core/shell particles gives it a so-called “soft touch”, i.e. the surface of the security paper feels very soft and smooth, but not purely paper-like. Depending on the amount of added core/shell particles, it is thus possible to obtain tactile surface properties which can be ascribed neither to pure paper nor to pure polymer film and combine the surface properties of the two materials. The added amount of core/shell particles also determines the degree of “film-likeness” of the paper, i.e. if the added amount is increased, the visible and tactile paper properties decrease and the visible and tactile film properties increase.

In a second embodiment of the present invention, the core/shell particles are present on the cellulose-containing substrate. This can be carried out by the introduction of a preferably aqueous dispersion of core/shell particles into the conventional sizing layer, by the application of a dispersion of core/shell particles instead of the conventional sizing layer or by the application of a dispersion of core/shell particles to a sizing layer that has already been applied. The application of these layers can take place either over the entire surface or over part of the surface of the cellulose-containing substrate, enabling targeted control of the areas on which the optically variable effect achieved by the core/shell particles is visible.

If a sizing layer is present, this may, irrespective of whether the core/shell particles are present therein or not, comprise all ingredients which are otherwise usual in papermaking, such as pigments, binders and the like, so long as they do not react with the core/shell particles in such a way that they adversely affect the optical properties thereof.

If the core/shell particles are incorporated into the conventional sizing layer or are applied to the finished cellulose-containing substrate instead of a sizing layer, this layer seals at least some of the pores present on the surface of the cellulose-containing substrate and thus penetrates into the substrate to a certain degree.

As already described above for the introduction of the core/shell particles into the paper stock, these also provide the security paper according to the invention with an optically variable appearance if the core/shell particles are present on the cellulose-containing substrate.

The smoothing process following conventional sizing is generally sufficient here to allow a regular order to form of the cores in a matrix formed from the shell material. Here too, the three-dimensional structures described above, at which reflection, interference and scattering of the incident light occur, are able to form.

Since these structures form better on a paper substrate the less porous the cellulose-containing substrate is, the visible optically variable colour effect is significantly more pronounced in a pre-sized paper than in a paper in which the core/shell particles are present in the sizing or in a layer which replaces the latter.

However, the more porous the cellulose-containing substrate, the greater an increase in the transparency of this substrate due to addition of the core/shell particles with retention of the optically variable properties. Depending on the desired effect, the person skilled in the art can therefore vary whether he introduces the core/shell particles preferentially into the paper substrate, a layer located directly on the latter or into a coating following the conventional sizing.

In all cases, however, the optically variable effect can be enhanced over the entire surface or over part of the surface by a specific subsequent pressure or temperature and pressure treatment.

The statements already made above regarding the mechanical and tactile properties of the security paper in accordance with the present invention also apply if the core/shell particles are present on the cellulose-containing substrate.

However, the core/shell particles may of course also be present both in and on the cellulose-containing substrate. The optically variable properties of the security paper as well as its film-likeness are thus enhanced.

A major advantage of the security paper according to the invention consists in that it can, in addition to the core/shell particles and the effects associated therewith, contain all conventional security features which are usually used in security papers.

These are not only the security features already described above, such as fluorescent particles or fibres, planchettes, watermarks or the like, which may already be present in the paper stock, but also, for example, security features which are applied to or introduced into the security paper after completion of papermaking, such as security threads, fluorescent dyes, infrared- or UV-active dyes, magnetic particles, electrically conductive particles, optically variable pigments, optically variable layers, optically variable prints, liquid-crystalline coatings, holograms, kinegrams, RFID elements, laser marks, chemical additives which become visible on illumination at certain wavelengths or on manipulation, microtexts, guillochés and the like.

These security features are either visible or can be rendered visible by means of aids and/or are machine-readable.

Preference is therefore given to an embodiment of the present invention in which the security paper, besides the core/shell particles, additionally has at least one further security feature, in particular one of the security features described above.

The present invention also relates to a process for the production of an optically variable security paper in which core/shell particles whose core is essentially solid and dimensionally stable and has an essentially mono-disperse size distribution and where the core is chemically bonded to the shell via an interlayer, the weight of the shell is equal to or greater than the weight of the core, and there is a difference between the refractive indices of the core material and shell material, are introduced into an aqueous paper pulp and subsequently converted into a paper sheet together with the conventional paper raw materials.

The core/shell particles here are usually introduced into the paper pulp in an amount of about 0.01 to 50% by weight, preferably 1 to 20% by weight, based on the dry weight of the paper.

As already described above, the degree of “film-likeness” of the paper can likewise be controlled by means of the amount of core/shell particles employed, like its surface properties and the optically variable appearance.

The core/shell particles can be introduced into the aqueous paper pulp both in solid form and also in dispersion. Preference is given to addition in the form of a predominantly aqueous dispersion of core/shell particles. Besides water, the dispersion may optionally also comprise various alcohols which are common as solvents.

The papermaking process subsequently proceeds with retention of the conventional process steps. However, it is advantageous for the papermaking process itself or at least one of the subsequent process steps to be associated with a pressure or temperature and pressure treatment of the paper, since this enables the optically variable properties of the paper to be set or enhanced particularly well.

The present invention likewise relates to a process for the production of an optically variable security paper in which a predominantly aqueous dispersion comprising core/shell particles whose core is essentially solid and has an essentially monodisperse size distribution and where the core is chemically bonded to the shell via an interlayer, the weight of the shell is equal to or greater than the weight of the core, and there is a difference between the refractive indices of the core material and shell material, is applied to at least part of the surface of an unsized or sized paper and subsequently dried.

The proportion of the core/shell particles in the aqueous dispersion here is 0.1 to 50% by weight, preferably 2 to 40% by weight and in particular 10 to 40% by weight, based on the weight of the aqueous dispersion.

The dispersion can be applied to the entire surface or part of the surface of the sized or unsized paper, depending on where on the paper an optically variable appearance is desired.

Suitable for this purpose are all conventional application techniques, such as, for example, the various printing processes, coating and spreading methods, spraying methods, etc.

For this purpose, the aqueous dispersions can also be mixed with all suitable solvents, binders or assistants which are usually used for application methods, so long as they do not adversely affect the optical properties of the core/shell particles.

Irrespective of whether the core/shell particles are present in or on the cellulose-containing substrate, subsequent pressure treatment or pressure and temperature treatment enables the optically variable properties of the security paper according to the invention to be emphasised, the film-like formation of the paper surface to be enhanced or the transparency of the substrate comprising the core/shell particles to be increased.

A subsequent process of this type can be, for example, a smoothing, pressing and/or embossing treatment, which is carried out over the entire surface or part of the surface of the substrate comprising the core/shell particles.

Particularly effective here are embossings, which result in high transparency and a particularly readily visible optically variable effect at the embossed point.

An aftertreatment of this type by pressure or temperature and pressure can be carried out immediately after paper production. The cellulose-containing substrate here may already contain further security features, such as water-marks, planchettes, fibres, etc. Further security features, such as, for example, security threads, fluorescent dyes, infrared- or UV-active dyes, magnetic particles, electrically conductive particles, optically variable pigments, optically variable layers, optically variable prints, liquid-crystalline coatings, holograms, kinegrams, RFID elements, laser marks, chemical additives which become visible on illumination at certain wavelengths or on manipulation, microtexts, guillochés and the like in suitable form, can subsequently be applied to and/or introduced into the cellulose-containing substrate. This is preferably carried out at the points of the substrate where only the conventional, but not subsequent pressure treatment has previously taken place.

However, it is likewise advantageous firstly to apply or introduce further security elements to or into the cellulose-containing substrates comprising core/shell particles before a subsequent strengthening pressure or temperature and pressure treatment is carried out. The subsequent pressure treatment here cannot be carried out only over part of the surface, but can also be carried out over the entire surface, producing virtual “sealing” of the other security features since, depending on the proportion of core/shell particles in the cellulose-containing substrate, a film-like surface can form, which may be advantageous, depending on the desired security product.

The present invention furthermore relates to the use of the optically variable security paper according to the invention for the production of documents of value of all types, for example for the production of banknotes, passports, identity documents, shares, bonds, certificates, cheques, credit notes, entry tickets, travel tickets and the like. In principle, all documents of value which are traditionally made from paper or paper-bonded materials (for example laminates), but also documents of value which are traditionally made from plastics, for example ID cards, access authorisation documents of all types and the like, can be produced using the security paper according to the invention.

The present invention therefore likewise relates to documents of value, in particular those described above, produced using the security paper in accordance with the present invention.

The security paper in accordance with the present invention has an optically variable character both when viewed from the top and on looking through it and high mechanical strength, tear strength and water-repellent properties and is insensitive to rapid soiling. It has a surface which differs in tactile terms from a pure paper surface through a particularly smooth, soft touch.

Variation of the composition and size of the added core/shell particles enables the optically variable properties of the security paper according to the invention to be controlled specifically in colour and intensity. By contrast, the amount of added core/shell particles influences not only the mechanical and tactile properties of the security paper, but also the degree of achievable film-like properties. Furthermore, the optically variable properties and the transparency of the security paper can be specifically emphasised by subsequent pressure or temperature and pressure treatment.

Straightforward integration of the production process according to the invention into the conventional papermaking process is likewise possible. In addition, the security paper according to the invention may additionally be provided with all conventional further security features which are generally usual for security products.

The present security paper according to the invention is thus eminently suitable for the simple production of a very wide variety of documents of value and provides the latter with both an uncopyable optical appearance and also excellent mechanical properties. It can therefore be employed highly successfully both for high-security products and also for the medium security segment.

1. Optically variable security paper for the production of documents of value, comprising a flat cellulose-containing substrate which comprises core/shell particles whose core is essentially solid and dimensionally stable and has an essentially monodisperse size distribution, where the core is chemically bonded to the shell via an interlayer, the weight of the shell is equal to or greater than the weight of the core, and there is a difference between the refractive indices of the core material and shell material.

2. Security paper according to claim 1, where the core/shell particles are present in and/or on the cellulose-containing substrate.

3. Security paper according to claim 1, where the cellulose-containing substrate is a security paper which comprises predominantly cellulose from vegetable fibres and/or rags.

4. Security paper according to claim 3, comprising cellulose fibres from cotton.

5. Security paper according to claim 1, where the cellulose-containing substrate is an unsized paper.

6. Security paper according to claim 1, where the cellulose-containing substrate is a sized paper.

7. Security paper according to claim 1, where the shell of the core/shell particles consists of a material which becomes flowable through an increase in pressure or pressure and temperature.

8. Security paper according to claim 1, where the core of the core/shell particles consists entirely or predominantly of an organic polymeric material which is either non-flowable or is flowable at a temperature above the melting point of the shell material.

9. Security paper according to claim 1, where the core of the core/shell particles consists entirely or predominantly of an inorganic material.

10. Security paper according to claim 1, where the difference between the refractive indices of the core material and shell material is at least 0.01.

11. Security paper according to claim 10, where the difference between the refractive indices is at least 0.1.

12. Security paper according to claim 1, where the core in the core/shell particles is bonded to the shell via a polymeric interlayer or via a surface functionalisation of the core.

13. Security paper according to claim 1, where the core and/or shell of the core/shell particles additionally comprises a contrast agent.

14. Security paper according to claim 1, where the core/shell particles have particle diameters of 50 to 800 nm.

15. Security paper according to claim 1, where the core/shell particles have a core:shell weight ratio in the range from 1:1 to 1:5.

16. Security paper according to claim 15, where the weight of the shell of the core/shell particles is greater than the weight of the core.

17. Security paper according to claim 1, which has at least one further security feature in addition to the core/shell particles.

18. Security paper according to claim 17, in which the additional security feature is present in the paper stock and/or is applied to and/or introduced into the finished paper.

19. Security paper according to claim 18, in which the additional security features are watermarks, planchettes, fibres, security threads, fluorescent dyes, infrared- or UV-active dyes, magnetic particles, electrically conductive particles, optically variable pigments, optically variable layers, optically variable prints, liquid-crystalline coatings, holograms, kinegrams, RFID elements, laser marks, chemical additives which become visible on illumination at certain wavelengths or on manipulation, microtexts, guillochés and the like.

20. Process for the production of an optically variable security paper according to claim 1, in which core/shell particles whose core is essentially solid and dimensionally stable and has an essentially monodisperse size distribution and where the core is chemically bonded to the shell via an interlayer, the weight of the shell is equal to or greater than the weight of the core, and there is a difference between the refractive indices of the core material and shell material, are introduced into an aqueous paper pulp and subsequently converted into a paper sheet together with the conventional paper raw materials.

21. Process according to claim 20, in which the core/shell particles are introduced into the paper pulp in an amount of 0.1 to 50 percent by weight, based on the dry weight of the paper.

22. Process according to claim 20, in which the core/shell particles are introduced into the paper pulp in a predominantly aqueous dispersion.

23. Process for the production of an optically variable security paper according to claim 1, in which a predominantly aqueous dispersion comprising core/shell particles whose core is essentially solid and has an essentially monodisperse size distribution and where the core is chemically bonded to the shell via an interlayer, the weight of the shell is equal to or greater than the weight of the core, and there is a difference between the refractive indices of the core material and shell material, is applied to at least part of the surface of an unsized or sized paper and subsequently dried.

24. Process according to claim 23, in which the proportion of the core/shell particles in the aqueous dispersion is 0.1 to 50% by weight.

25. Process according to claim 20, in which the paper comprising the core/shell particles is smoothed, pressed and/or embossed over the entire surface or part of the surface.

26. Process according to claim 20, in which the paper comprising the core/shell particles is firstly provided with various additional security features and subsequently smoothed, pressed and/or embossed.

27. Process according to claim 26, in which the additional security features are introduced into the paper stock and/or applied to and/or introduced into the finished paper.

28. Process according to claim 27, in which the additional security features are watermarks, planchettes, fibres, security threads, fluorescent dyes, infrared- or UV-active dyes, magnetic particles, electrically conductive particles, optically variable pigments, optically variable layers, optically variable prints, liquid-crystalline coatings, holograms, kinegrams, RFID elements, laser marks, chemical additives which become visible on illumination at certain wavelengths or on manipulation, microtexts, guillochés and the like.

29. A method of production of documents of value, such as banknotes, passports, identity documents, shares, bonds, certificates, cheques, credit notes, entry tickets, travel tickets and the like comprising using optically variable security paper according to claim 1.

30. Documents of value, such as banknotes, passports, identity documents, shares, bonds, certificates, cheques, credit notes, entry tickets, travel tickets and the like, comprising a security paper according to claim 1.
